(19) United States
(12) Patent Application Publication
(10) Pub. No.: US 2020/0122276 A1
(43) Pub. Date: Apr. 23, 2020

(54) METHODS AND DEVICE FOR MONITORING A BEAM GUIDING OPTICAL UNIT IN A LASER PROCESSING HEAD DURING LASER MATERIAL PROCESSING

(71) Applicant: Precitec GmbH & Co. KG, Gaggenau (DE)

(72) Inventors: David Blázquez-sánchez, Gaggenau (DE); Niklas Weckenmann, Rastatt (DE)

(21) Appl. No.: 16/627,858

(22) PCT Filed: Dec. 11, 2018
(86) PCT No.: PCT/EP2018/084308

§ 371 Date: Dec. 31, 2019

(30) Foreign Application Priority Data
Dec. 22, 2017 (DE) 10 2017 131 147.5

(51) Int. Cl. B23K 26/70; B23K 26/046; B23K 26/03

(52) U.S. Cl. CPC B23K 26/707; B23K 26/705; B23K 26/032; B23K 26/046

(57) ABSTRACT

A method and a device for monitoring a beam guiding optics in a laser machining head during laser material machining, wherein a physical parameter of at least one optical element of the beam guiding optics is measured during the laser material machining. The parameter correlates with the degree of soiling of the at least one optical element. The current focal position is detected for focal position control by a spatially resolving sensor measuring the beam diameter in the region of the focus, and an evaluation circuit determines the current focal position from the output signal of the spatially resolving sensor and outputs an actuating signal for an actuator.

### REFERENCE TO RELATED APPLICATIONS

This application is a U.S. national stage application of PCT/EP2018/084308, filed Dec. 11, 2018, which claims priority to German patent application No. 10 2017 131 147.5, filed Dec. 22, 2017, the entire content of both of which is incorporated herein by reference.

### FIELD OF THE INVENTION

The invention relates to a method and a device for monitoring a beam guiding optics in a laser machining head and for controlling the focal position in laser material machining.

### BACKGROUND OF THE INVENTION

One problem in laser material machining is the so-called “thermal lens”, which results from the heating of optical elements for laser beam guiding and focusing generated by the laser power, in particular in the multi-kilowatt range, and the temperature dependence of the refractive index of optical glasses. The thermal lens leads to a focus shift along the beam propagation direction during laser material machining.

Primarily, there are two mechanisms during the laser material machining process which lead to the heating of the optical elements. One cause is an increase in laser power and the other cause is soiling of the optical elements. Furthermore, it is possible for the optical elements to undergo mechanical deformation, which leads to a change in refractivity. For example, the mechanical deformation may be caused by a thermal expansion of the socket of the optical elements. In order to ensure high-quality laser machining, it is necessary to detect the respective focal position and to compensate the focal position shift, i.e., to provide a fast and accurate focal position control.

DE 10 2011 007 176 A1 describes a device for focusing a laser beam onto a workpiece, comprising at least one transmissive optical element arranged at a tilt angle with respect to a plane perpendicular to the beam axis of the laser beam, and a spatially resolving detector for detecting laser radiation reflected back at the transmissive optical element. From the image captured by the detector, e.g. a CCD chip, an image evaluation device determines the size or the diameter of the back-reflected laser radiation on the detector, from which, in turn, the focal position can be determined for focal position control.

DE 10 2013 021 151 B3 relates to a method for at least partial compensation of a thermal lens in an optical arrangement. The optical arrangement includes one or more optical elements in which a thermal lens is formed. In the beam path of the laser beam, an optical compensation arrangement with at least one optical compensation element is arranged, the optical compensation element exhibiting, in a passage region of the laser radiation, an inverse change in refractive index with temperature with respect to at least one of the optical elements. The diameter of the compensation element is chosen such that the thermal time constant thereof in the passage region comes as close as possible to that of the at least one optical element. With the method and the optical arrangement resulting therefrom, it is also possible to at least approximately compensate for transient effects in a simple manner when a thermal lens is formed. A thermal lens caused by soiling cannot be compensated.

DE 10 2007 039 878 A1 describes a device and a method for stabilizing the focal position in optics for high-power laser radiation for laser material machining, wherein the focus is moved in the opposite direction by means of movable optical elements and a control when a laser beam-induced focal position change occurs, such that the focus retains the desired position overall. The information required for correction may be calculated via the current power of the laser beam. For measuring that power, a plane-parallel plate, at which a small, constant fraction of the laser beam is deflected onto an optical sensor, may be arranged in the optical path of the optical system at an angle to the optical axis. Again, a compensation of a thermal lens caused by soiling is not possible.

DE 10 2011 054 941 B3 relates to a device for correcting the thermal shift of the focal position. The device is provided with a sensor for determining the current focal position of the laser beams, a computation unit for comparing the current focal position with a desired focal position stored in a memory and for deriving correction data from the comparison of the current and the desired focal position, and a correction unit including at least one variable optical element for changing the focal position according to the correction data. Here, the sensor is arranged at the location of the focus of a back reflection of the laser radiation reflected by one of the surfaces of one of the last optical elements in the beam direction upstream of the material to be machined.

Although in the current state of the art, a focal position monitoring for focal position compensation can be performed even for a high degree of soiling, there is a risk that the soiled optics will be completely destroyed, since the soiling is not detected.

DE 101 13 518 B4 relates to a method for measuring the degree of soiling of a protective glass located, in a laser machining head, on the beam output side of a lens arrangement in the laser machining head through which a laser beam passes. For this purpose, a first radiation detector arrangement is arranged outside the laser beam and observes a surface of the protective glass penetrated by the laser beam in order to measure the intensity of the scattered radiation arising therefrom, which is caused by the scattering of the laser beam at particles adhering to the protective glass. A second radiation detector arrangement measures the intensity of a partial beam deflected from the laser beam in order to detect the laser power. From the ratio of scattered radiation to laser power, the degree of soiling of the observed surface of the protective glass can be derived. Focal position compensation is not provided here.

### SUMMARY OF THE INVENTION

Based on the above, the object of the disclosure is to provide a method and a device which allow for a real-time control of the focal position in laser material machining while maximizing the service life of the optics.

According to the disclosure, for monitoring a beam guiding optics in a laser machining head, a physical parameter of at least one optical element of the beam guiding optics which correlates with the degree of soiling of the optical element is measured during laser material machining and the focal position is acquired for focal position control. A measured focal position change is then compensated for as long as the measured value of the physical parameter of the optical element of the beam guiding optics has not yet reached an associated critical value. However, when the measured value of the physical parameter of the at least one optical element of the beam guiding optics reaches the associated critical value, an error signal is output. In this way, the simultaneous detection of the focal position shift, also referred to as focus shift in the following, and the degree of soiling of the optical elements is made possible, thereby, on the one hand, ensuring high quality machining by correction of the focal position and, on the other hand, preventing damage to the beam guiding optics due to excessive heating due to soiling.

In one embodiment of the disclosure, the physical parameter to be measured of the one or more optical elements of the beam guiding optical system is intended to be the temperature thereof.

In an advantageous embodiment of the disclosure, the temperature of at least two optical elements of the beam guiding optics is to be measured and the measured temperature values of the individual optical elements of the beam guiding optics are further to be compared with each other in order to detect soiling of an optical element via a temperature increase which is significant compared to the temperature increases of the other optical elements.

Since both a large increase in the laser power and a high degree of soiling of the beam guiding optics result in a focal position shift, it is advantageous, when the power of a machining laser beam is measured and a power profile determined therefrom is compared with the temperature profile of the at least one optical element in order to detect a soiling-related focus shift, to optionally interrupt the laser machining for maintenance purposes.

According to a further embodiment of the disclosure, the physical parameter of the at least one optical element is to be the scattered light emanating therefrom. The scattered light measurement may be intended to be used alone or in combination with a temperature measurement. By combining the detection of two parameters, the reliability of the soiling detection can be improved.

Advantageously, the power of a machining laser beam is also measured and a power measurement value is compared with a scattered light measurement value of the at least one optical element in order to detect soiling.

In another advantageous embodiment of the disclosure, for detecting the focal position, a back-reflection from an optical element arranged in the machining laser beam converging in the focus is to be coupled out of the machining laser beam path in order to measure at least one beam diameter in the region of the focus and to determine the focal position from the at least one beam diameter.

It is advantageous when a beam caustic in the focus region is determined from at least two measured beam diameters in order to determine the focal position from the determined beam caustic. This allows a direct real-time or in-line beam caustic measurement in order to ensure a precise determination of focal position in real time during the laser machining process.

Furthermore, according to the disclosure, a device for monitoring a beam guiding optics in a laser machining head during laser material machining is provided, said device comprising at least one sensor for measuring a physical parameter of at least one optical element of the beam guiding optics during laser material machining, said parameter correlating with the degree of soiling of the optical element, and a spatially resolving sensor for measuring the beam diameter in the region of the focus for detecting the current focal position. An evaluation circuit, to which an output signal of the spatially resolving sensor can be supplied, determines the current focal position from the output signal of the spatially resolving sensor and outputs an actuating signal for an actuator, which then displaces at least one optical element of the beam guiding optics for focal position control. A monitoring circuit compares the measured value(s) of the parameter of the optical element(s) of the beam guiding optics with an associated critical value and outputs an error signal when a value of the measured parameter of the optical element(s) of the beam guiding optics reaches the associated critical value. Thus, damage to the beam guiding optics due to excessive heating caused by soiling can be prevented.

Advantageously, the physical value of the at least one optical element is the temperature thereof. Thus, a temperature sensor for measuring the temperature of individual optical elements of the beam guiding optics is provided as a sensor which may be configured as a thermos sensor, thermocouple or non-contact temperature sensor such as radiation thermometer, thermopile or the like.

For a reliable distinction between the different causes of a thermal lens, the temperature monitoring circuit further is to be configured to compare the measured temperature values of at least two optical elements of the beam guiding optics with each other in order to detect a soiling of an optical element via a temperature increase which is significant with respect to the temperature increases of the other optical elements.

In another embodiment of the disclosure, a power sensor is provided for measuring the power of a machining laser beam, and the temperature monitoring circuit is further configured to compare a power profile determined from the measured power with a temperature profile of the at least one optical element in order to detect a soiling and to distinguish the thermal lens initiated thereby from a thermal lens due to increased laser power. The power measurement does not only allow a double check of the temperature profile, but also a double check of the focal position. In case all optics are “clean”, the desired values for the focal position can be determined as a function of the laser power. At a given laser power, deviations from the desired temperature values and from the desired focal position give an indication of soiling problems.

In another embodiment of the device according to the disclosure, the at least one sensor for measuring a physical parameter of the at least one optical element is intended to be a scattered light sensor. When a power sensor for measuring the power of the machining laser beam is provided at the same time, then a correspondingly adapted monitoring circuit (50) is able to compare a power measurement value with a scattered light measurement value of the at least one optical element in order to reliably detect soiling.

Advantageously, the sensor for measuring the machining laser beam is a spatially resolving sensor.

An advantageous embodiment of the disclosure is characterized in that an optical element arranged in the machining laser beam converging toward the focus, in particular the last optical element of the beam guiding optics, is inclined with respect to the optical axis of the machining laser beam path such that a back reflection from the optical element is coupled out of the machining laser beam path and is directed to the spatially resolving sensor, wherein, in particular for deflecting and unfolding the back reflections coupled out, a plane-parallel plate is provided as a deflecting element between the last optical element of the beam guiding optics and the spatially resolving sensor, said plane-parallel plate dividing the one or more back reflections into a plurality of back reflections and directing them to the spatially resolving sensor. As a result, a beam measurement usable for focal position correction can be achieved in a structurally compact manner.

Advantageously, the evaluation circuit is to be further configured to determine, from the output signal of the spatially resolving sensor, at least two beam diameters in the region of the focus and to determine a beam caustics in the focus region from the determined beam diameters in order to determine the focal position from the determined beam caustics.

### BRIEF DESCRIPTION OF THE DRAWINGS

The disclosure will be exemplarily explained in more detail below with reference to the drawing. In the figures:

FIG. 1 is a schematic diagram of a laser machining head comprising a device for monitoring a beam guiding optics and for controlling the focal position during laser material machining according to the disclosure;

FIG. 2 is a schematic diagram of the beam guiding optics of a laser machining head comprising sensors for temperature monitoring and focal position control;

FIG. 3 is a schematic diagram of the beam guiding optics according to FIG. 2 comprising a focal position sensor according to another embodiment of the disclosure;

FIG. 4 is a schematic profile of a laser beam caustic in the region of the laser focus;

FIG. 5 is a schematic diagram of the beam guiding optics and the focal position sensor according to FIG. 3 with an additional power sensor, and

FIG. 6 is a schematic diagram of the beam guiding optics in a laser machining head comprising a focal position sensor according to another embodiment of the disclosure.

### DETAILED DESCRIPTION OF THE INVENTION

In the various figures of the drawing corresponding elements are designated with the same reference signs.

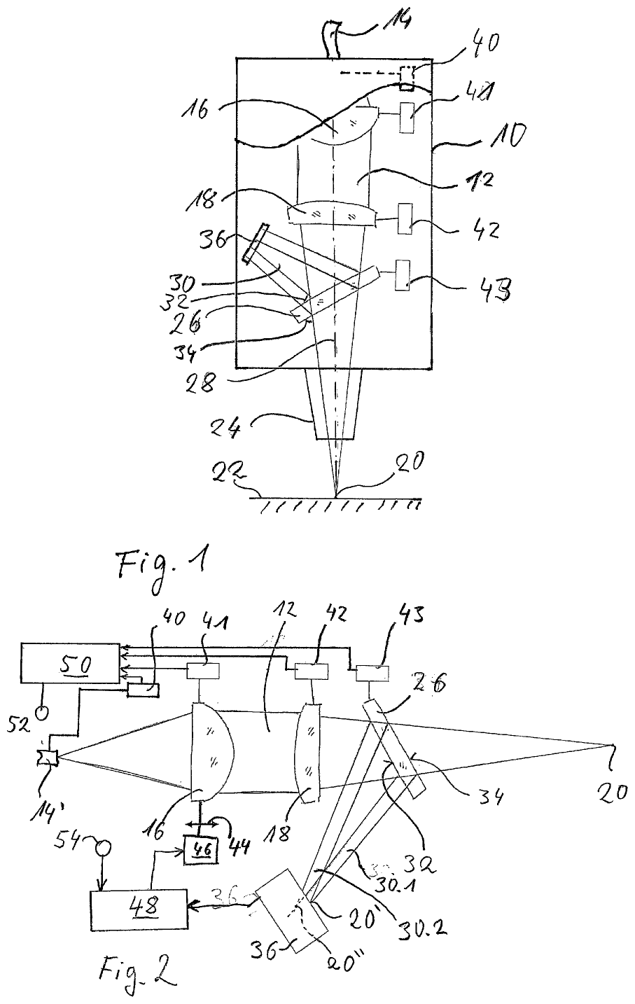

FIG. 1 schematically shows a laser machining head 10 through which a machining laser beam 12 is guided. The machining laser light is supplied to the laser machining head 10 via an optical fiber 14, for example. The machining laser beam 12 emerging from the optical fiber 14 is collimated by a first optics 16 and focused by a focusing optics 18 into a laser focus 20 on a workpiece 22. Usually, a protective glass 26 intended to protect the interior of the laser machining head and in particular the focusing optics 18 from soiling, e.g. caused by splashing or smoldering, is arranged between the focusing optics 18 and a beam nozzle 24, through which the convergent machining laser beam 12 is focused onto the workpiece 22.

The first optics 16 and the focusing optics 18 are shown as individual lenses, but may also be lens groups in a known manner. In particular, the first optics 16 may be formed by movable lenses of a zoom system collimating the machining laser beam 12.

In order to couple back reflections 30 for a focal position control out of the machining laser beam path, the protective glass 26 is inclined with respect to the optical axis 28 of the beam guiding optics such that the angle between the optical axis 28 and the refractive and reflective surfaces 32, 34 of the protective glass is different from 90°. As shown schematically in FIG. 1, the back reflections 30 are directed onto a spatially resolving sensor 36. As a spatially resolving sensor 36, any sensor capable of determining a diameter of the laser beam incident on the sensor, i.e., the laser back reflection for beam measurement, may be used. For example, it would also be possible to use a sensor operating according to the so-called knife-edge method, wherein the light beam incident on the sensor is gradually covered as in the case of the cutting edge test. Conveniently, however, a camera is used as a spatially resolving sensor 36, the sensor surface of which is formed by a CCD sensor, for example.

In order to measure a physical parameter of at least one of the optical elements 16, 18, 26 of the beam guiding optics during laser material machining, said parameter correlating with the degree of soiling of the at least one optical element, such as the temperature or the scattered light emitted by the element, each of the optical elements 16, 18, 26 is associated with corresponding sensors.

For example, in order to detect the temperature of the fiber end 14′ of the optical fiber 14 and the individual optical elements of the beam guiding optics, i.e., the temperature of the first optics 16, the focusing optics 18, and the protective glass 26, for a detection of a thermal lens and soiling, each of these elements is associated with a temperature sensor 40, 41, 42 and 43. As a temperature sensor 40, 41, 42, 43 a thermo sensor or a thermocouple in engagement with the edge or a socket (not shown) of the respective optical element may be used. However, it is also possible to use non-contact measuring temperature sensors such as radiation thermometers, thermopiles, or the like. Furthermore, scattered light sensors which provide comparable information as the temperature sensors may be used. The signals of scattered light sensors are the higher the higher the power or the degree of soiling. A combination of temperature and scattered light measurement is ideal.

For adjusting a focal position and for focal position correction, at least one of the imaging optical elements of the beam guiding optics, i.e., in the example shown, the first optics 16 and/or the focusing optics 18, are movably arranged in the direction of the optical axis thereof such that they can be moved by a suitable actuator 46. As indicated in FIGS. 2, 3 and 5 by the double arrow 44, preferably the first optics 16 is moved by the actuator 46 to perform a focal position correction.

In order to control the focal position correction based on a detected focal position shift, an output signal of the spatially resolving sensor 36 is supplied to an evaluation circuit 48 which determines the current focal position from the output signal of the spatially resolving sensor 36 and outputs a control signal for the actuator 46 such that, in the illustrated example, the first optics 16 is moved accordingly.

In order to be able to use the temperature values measured by individual temperature sensors 41, 42, 43 for monitoring the beam guiding optics, said values are supplied to a temperature monitoring circuit 50, which compares the measured temperature values of the individual optical elements of the beam guiding optics with each other and also with an associated critical temperature value and outputs an alert or an error signal, e.g., via an output 52, when a temperature value of an optical element of the beam guiding optics indicates a significant increase in temperature or reaches the associated critical temperature value. The error signal may—as described in more detail below—be used to interrupt the laser material machining for maintenance then becoming necessary. The error signal from the output 52 may also be supplied via an input 54 of the evaluation circuit to stop another focal position control. Other physical parameters correlating with soiling, such as scattered light, may be used in a corresponding manner as the temperature described here and below for illustrating the disclosure in a preferred embodiment.

As can be seen particularly well in FIG. 2, for the purpose of beam measurement, a laser back reflection 30.1 is directed from the last transparent optical surface 34 of the protective glass 26, i.e., from the surface 34 opposite the interaction zone, to the spatially resolving sensor 36 before the laser process.

Here, the spatially resolving sensor 36 is positioned outside the optical axis of the machining laser beam 12 such that the focus 20′ of the back reflection 30.1 is on the sensor surface.

A second back reflection 30.2 from the surface 32 of the protective glass 26 facing the focusing optics 18 is likewise directed to the spatially resolving sensor 36, the focus 20″ of the second back reflection 30.2 being behind the sensor surface indicated by dashed lines in FIG. 2, however. In order to separate the areas of incidence of both back reflections 30 on the sensor surface of the spatially resolving sensor 36 further from each other, a planar optical element such as a protective glass with a greater thickness may be used.

Therefore, a focal position control is used during laser material machining for compensating a so-called focus shift, i.e., a shift of the focus along the optical axis 28 of the machining laser beam path, using the spatially resolving sensor 36, that is, for example, a camera the output signal of which, i.e., the image data thereof, are used by the evaluation circuit to determine the beam diameter of the back reflections in the region of the focus and to obtain a control signal for the actuator 46 for focal position correction therefrom.

At the same time, the temperature values of the individual optical elements of the beam guiding optics are determined during laser material machining by means of the temperature sensors 41, 42, 43, so that the measured temperature values may be compared with the determined focal position. When the laser power is increased during laser material machining, all the temperature sensors 41, 42, 43 will measure an increase in the temperature of the associated optical elements, i.e., the first optics 16, the focusing lens 18, and the protective glass 26. By comparison of these temperature values with one another and/or with temperature values characterizing the respective optical elements which are to be expected upon the occurring laser power change, it can be determined whether the increase in the temperature of the individual optical elements is only due to the increase in the laser power or also due to soiling. Thus, the focus shift determined by means of the spatially resolving sensor 36 (for example, a camera) and the evaluation circuit 48 is compensated by a corresponding shift of the first optics 16 (or another optics), as long as there is no or only little soiling.

If there is soiling of an optical element, such as the protective glass 26, a significant temperature increase is measured for the protective glass 26 by the temperature sensor 43. By comparison with the other temperature values and/or a characteristic temperature value associated with the protective glass 26 for the occurring increase in the laser power, it can be recognized that the temperature increase of the protective glass 26 is caused not only by the increase in power in the machining laser beam 12 but also by the soiling. The temperature monitoring circuit 50 may then issue a warning that is recognized by an operator or an automatic machine control to later perform maintenance actions at an appropriate time. The focus shift measured by the spatially resolving sensor 36 is compensated by shifting the corresponding optics, that is, the first optics 16 in the illustrated example, since the laser material machining is not interrupted.

When the temperature of the optical element identified as soiled reaches an associated critical temperature, then a “fault” in the beam guiding optics is detected by comparison with the other temperature values. In this case, the measured focus shift is not compensated, but a warning, such as an indication that “maintenance is necessary”, is issued. At the same time, the laser machining is turned off in order to prevent destruction of the soiled optical element.

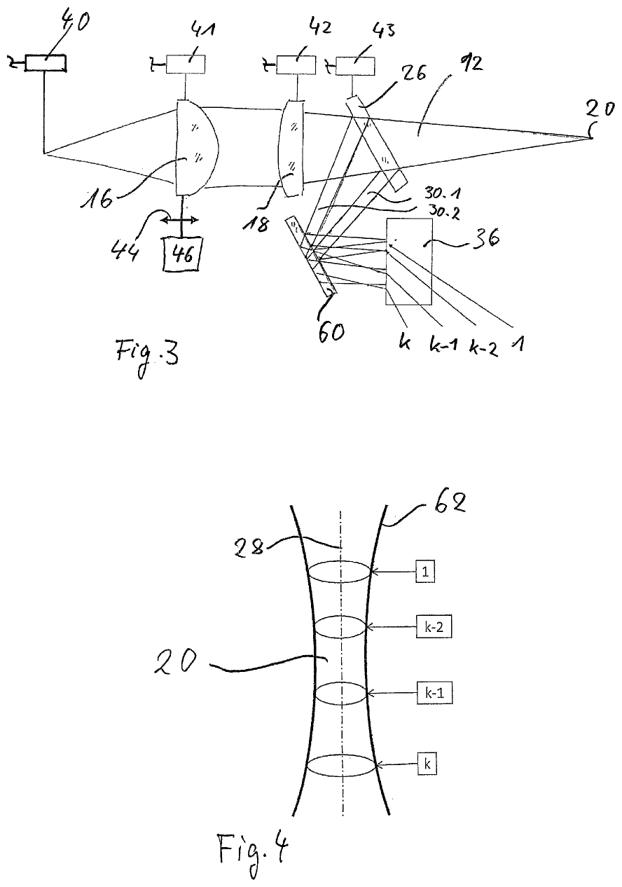

As shown in FIG. 3, the two back reflections 30.1, 30.2 from the last optical element of the beam guiding optics are ideally deflected by the protective glass 26 with another transparent optical element, i.e., a deflecting element 60, before the laser process. As the deflecting element 60, a plane-parallel plate may be provided. However, it is also possible to use a wedge plate as deflecting element 60, as protective glass 26, or as another deflecting element in order to further separate the points or areas of incidence of the individual partial back reflections on the spatially resolving sensor 36, that is, on the sensor surface thereof. It is also possible to make the rear surface of the deflecting element 60 reflective in order to avoid light losses for the corresponding back reflections. It is also conceivable to provide the front surface of the deflecting element 60 with a coating such that the intensity of the two incident back reflections 30.1 and 30.2 is distributed uniformly among the respective partial back reflections. If a wedge plate is used as the protective glass 26, then the protective glass 26 is not necessarily installed in an inclined manner.

Using the multiple back reflections generated in this way, the beam diameter in the region of the focus may be measured at several locations, since the optical path of the light from the last surface of the focusing optics 18 to the sensor surface of the spatially resolving sensor 36 is different for each of the back reflections, that is, in part shorter and in part longer than the nominal focal length which determines the focal position. As shown in FIG. 3, the four back reflections arising from the two back reflections 30 from the protective glass 26 via the multiple reflections at the deflecting element 60 occur at the locations 1, k-2, k-1, and k. The beam diameters determined by the spatially resolving sensor 36 in these regions of the sensor surface thereof are shown schematically in FIG. 4. It thus turns out that, in the regions 1 and k-2, beam diameters are detected at locations in front of the focus 20, while, in the regions k-1 and k, beam diameters are detected at locations behind the focus 20. By measuring a plurality of beam diameters along the beam propagation direction in the region of the nominal focus 20, it is possible to approximately determine the beam caustic 62 in order to then determine the real focal position of the machining laser beam 12 from the beam caustic 62.

In order to further increase the number of back reflections emanating from the deflection element 60, the deflection element 60 may have a plurality of stacked plane-parallel plates. Here, the individual surfaces of the stacked plane-parallel plates may be coated such that the intensity of the back reflections 30.1, 30.2 coupled out of the laser machining beam is evenly distributed among the plurality of partial back reflections.

As is shown with reference to FIG. 5, when using a suitable design of the deflecting element 60, i.e., when using a transparent deflecting element 60, the portion of the two back reflections 30 passing through the deflecting element 60 may be supplied to a sensor for measuring the power of the machining laser beam 12, i.e., a power sensor 64. The power signal supplied by the power sensor 64 for power measurement, the time profile of which shows an increase in laser power, a decrease in laser power, or a constant laser power in laser material machining, may then be used when comparing the measured temperature values of the individual optical elements of the beam guiding optics to clearly attribute temperature increases to a laser power increase and to be able to reliably detect soiling of individual optical elements of the beam guiding optics. In particular, a correlation between the power profile of the machining laser beam 12 and the temperature profile of an optical element indicates that there is no soiling, while a temperature profile of an optical element not being correlated with the power profile of the machining laser beam 12 indicates possibly severe soiling. The power measurement not only allows to double check the temperature profile, but also to double check the focal position, since in the case that all optics are “clean”, desired values for the focal position can be determined as a function on the laser power, which then can be compared with the measured actual focal position at a given laser power. For a given laser power, therefore, deviations from the desired temperature values and from the desired focal position give an indication of soiling problems.

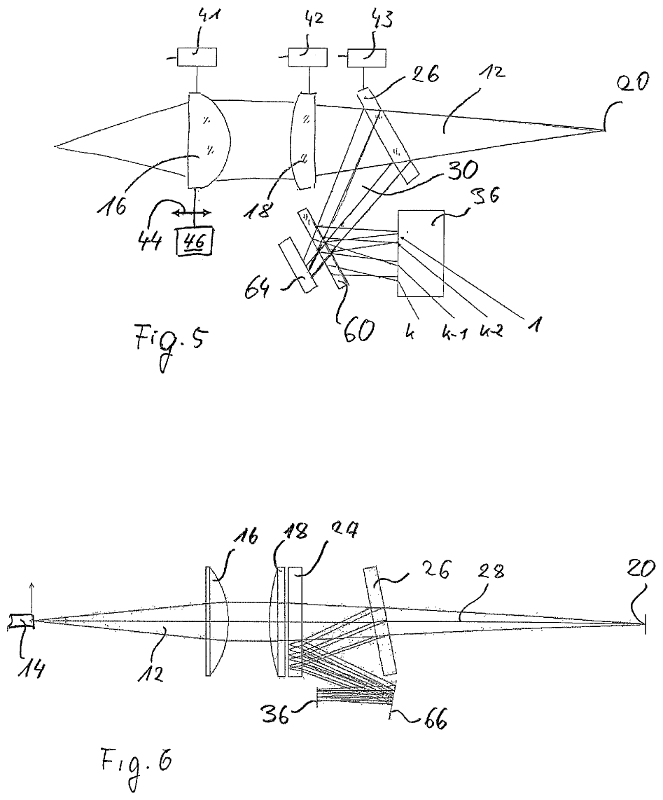

FIG. 6 shows a beam guiding optics for a laser machining head, comprising, in addition to the first optics 16 for collimating the machining laser beam supplied via the optical fiber 14, the focusing optics 18, and the protective glass 26, a further protective glass 27 arranged close behind the focusing optics 18 and aligned perpendicularly to the optical axis 28. The further protective glass 27 serves as a deflecting element dividing the two back reflections from the last protective glass 26 into four back reflections, which are then directed by a mirror 66 onto the spatially resolving sensor 36. Depending on the size of the sensor surface of the spatially resolving sensor 36, all or only some of the back reflections may then be used for the beam measurement in the region of the focus.

1. A method for monitoring a beam guiding optics in a laser machining head during laser material machining, wherein
a physical parameter of at least one optical element of the beam guiding optics that correlates with the degree of soiling of the at least one optical element is measured during laser material machining;
the focal position is detected for focal position control;
the measured focal position is compensated for as long as the measured value of the physical parameter of the at least one optical element of the beam guiding optics has not yet reached an associated critical value; and
an error signal is output when the measured parameter value of the at least one optical element of the beam guiding optics reaches the associated critical value, characterized in that the physical parameter of the at least one optical element is the temperature thereof, that the temperature of at least two optical elements is measured, and that the measured temperature values of the individual optical elements of the beam guiding optics are further compared with each other in order to detect soiling of an optical element by a temperature increase that is markedly higher than the temperature increases of the other optical elements.

2.-3. (canceled)

4. The method according to claim 1, characterized in that the power of a machining laser beam is measured and a power profile determined therefrom is compared with a temperature profile of the at least one optical element in order to detect soiling.

5.-6. (canceled)

7. The method according to claim 1, characterized in that, for detecting the focal position, a back reflection is coupled out of the machining laser beam path by an optical element arranged in the machining laser beam converging toward the focus in order to measure at least one beam diameter in the region of the focus and to determine the focal position from the at least one beam diameter.

8. The method according to claim 3, characterized in that a beam caustic in the focus region is determined from at least two measured beam diameters in order to determine the focal position from the determined beam caustic.

9. A device for monitoring a beam guiding optics in a laser machining head (10) during laser material machining, comprising:
at least one sensor for measuring a physical parameter of at least one optical element (16, 18, 26) of the beam guiding optics during the laser material machining, said parameter correlating with the degree of soiling of the at least one optical element;
a sensor for measuring a machining laser beam in the region of the focus for detecting the current focal position;
an evaluation circuit suppliable with an output signal of the sensor and configured to determine the current focal position from the output signal of the sensor and output a control signal for an actuator configured to displace at least one optical element of the beam guiding optics for focal position control; and
a monitoring circuit configured to compare the measured parameter value of the at least one optical element of the beam guiding optics with an associated critical value and to output an error signal when a parameter value of the at least one optical element of the beam guiding optics reaches the associated critical value, characterized in that the at least one sensor for measuring a physical parameter of the at least one optical element is a temperature sensor, characterized in that the monitoring circuit is further configured to compare the measured temperature values of at least two optical elements of the beam guiding optics with each other in order to detect soiling of an optical element by a temperature increase which is markedly higher than the temperature increases of the other optical elements.

10.-12. (canceled)

13. The device according to claim 9, characterized in that thermo sensors, thermocouples or non-contact temperature sensors such as radiation thermometers, thermopiles or the like are provided as temperature sensors.

14. (canceled)

15. The device according to claim 9, characterized in that, for measuring the power of the machining laser beam, a power sensor is provided, and that the monitoring circuit is further configured to compare a power profile determined from the measured power with a temperature profile of the at least one optical element in order to detect soiling.

16. The device according to claim 9, characterized in that the sensor for measuring the machining laser beam is a spatially resolving sensor.

17. The device according to claim 16, characterized in that an optical element arranged in the machining laser beam converging towards the focus, in particular the last optical element of the beam guiding optics, is inclined with respect to the optical axis of the machining laser beam path such that a back reflection from the optical element is coupled out of the machining laser beam path and directed to the spatially resolving sensor.

18. The device according to claim 17, characterized in that, for deflecting and unfolding the one or more back reflections coupled out, a plane-parallel plate is provided as a deflecting element between the last optical element of the beam guiding optics and the spatially resolving sensor, said plane-parallel plate dividing the one or more back reflections into a plurality of back reflections and directing them to the spatially resolving sensor.

19. The device according to claim 18, characterized in that the evaluation circuit is further configured to determine at least two beam diameters in the region of the focus from the output signal of the spatially resolving sensor and to determine a beam caustic in the focus region from the determined beam diameters in order to determine the focal position from the determined beam caustic.
